(19) United States
(12) Patent Application Publication
(10) Pub. No.: US 2009/0214712 A1
(43) Pub. Date: Aug. 27, 2009

(54) Milk-Based Beverage and Method for Preventing Off-Flavors in a Milk-Based Beverage

(75) Inventors: Young C. Kang, Alpharetta, GA (US); Matthew N. Lecky, Frisco, TX (US)

Correspondence Address: SUTHERLAND ASBILL & BRENNAN LLP, 999 PEACHTREE STREET, N.E., ATLANTA, GA, 30309, US

(73) Assignee: The Coca Cola Company, Atlanta, GA (US)

(21) Appl. No.: 12/371,639

(22) Filed: Feb. 16, 2009

Related U.S. Application Data
(60) Provisional application No. 61/030,338, filed on Feb. 21, 2008.

(51) Int. Cl. A23L 1/302; A23C 9/00; A23L 1/303; A23L 1/304

(52) U.S. Cl. 426/73; 426/580; 426/72; 426/74

(57) ABSTRACT

The present disclosure relates to a milk-based beverage comprising a milk component and a catechin-containing component. The milk component includes milk fat in an amount of at least about 0.2% by weight of the milk-based beverage. The catechin-containing component, wherein the catechin-containing component prevents off-flavors in the milk-based beverage. A method for preventing off-flavors in a milk-based beverage comprising a milk component including milk fat in an amount of at least about 0.2% by weight of the milk-based beverage is also provided.

### CROSS-REFERENCE TO RELATED APPLICATIONS

This application claims priority under 35 U.S.C. §119(e) to U.S. Provisional Patent Application No. 61/030,338, filed on Feb. 21, 2008, the disclosure of which are expressly incorporated herein by reference

### TECHNICAL FIELD

This invention generally relates to milk-based beverages and methods for preventing off-flavors in milk-based beverages.

### BACKGROUND OF THE INVENTION

In consumer applications, dairy product may be sensitive to oxidation by heat and light. Shelf stable dairy products may be susceptible to oxidation (e.g., photo-oxidation, auto-oxidation, lipid oxidation, or the like, or combinations thereof) due to the long storage time and the storage temperatures required in commercial applications. In addition, transportation and handling of beverages can expose the dairy products to high temperatures and/or light (e.g., sunlight or UV light). The oxidation of milk fats and/or milk proteins in the dairy products is self-propagating and may lead to the formation of strong off-flavors, for example rancid flavors.

Therefore, it would be desirable to provide a dairy containing beverage which avoids the aforementioned disadvantages to be used in commercial applications.

### SUMMARY OF THE INVENTION

The present disclosure encompasses a milk-based beverage comprising a milk component and a catechin-containing component. The milk component includes milk fat in an amount of at least about 0.2% by weight of the milk-based beverage. The catechin-containing component, wherein the catechin-containing component prevents off-flavors in the milk-based beverage.

The present disclosure also encompasses a method for preventing off-flavors in a milk-based beverage comprising a milk component including milk fat. The milk fat may be present in an amount of at least about 0.2% by weight of the milk-based beverage. The method comprises adding a catechin-containing component to the milk-based beverage.

Other objects, features, and advantages of this invention will be apparent from the following detailed description, drawing, and claims.

### DETAILED DESCRIPTION OF THE EMBODIMENTS

As summarized above, this disclosure encompasses embodiments of a milk-based beverage and a method for preventing off-flavors in a milk-based beverage. As used herein “off-flavors” refers to any flavors which may generally be perceived by a consumers as unacceptable in taste and/or aroma from milk. Examples of off-flavors may include, but is not limited to, light activated, sunlight activated, sun struck, rancid, butyric, goaty, bitter, cardboardy, papery, metallic, tallowy, oily, painty, fishy, old, cooked, scorched, caramelized, musty, oxidized, or combinations thereof. As used herein, “prevent” refers to the inhibition or suppression of off-flavors.

Embodiments of the milk based beverage comprises a milk component and a catechin-containing component. Embodiments of the milk component may be cows milk, goat's milk, buffalo milk, or other milks from a ruminant. Suitable embodiments of the milk component may comprise cream, whole fat milk, 2% milk fat milk, semi-skimmed milk, 1% milk fat milk, powdered whole fat milk, powdered semi-skimmed milk, or combinations thereof. In particular embodiments, the milk component may be present in an amount of 1% by weight of the milk-based beverage to about 100% by weight of the milk-based beverage. In more particular embodiments, embodiments, the milk component may be present in an amount of 2% by weight of the milk-based beverage to about 60% by weight of the milk-based beverage. In still more particular embodiments, embodiments, the milk component may be present in an amount of 4% by weight of the milk-based beverage to about 40% by weight of the milk-based beverage.

Embodiments of the milk component may include milk fat in an amount of at least about 0.2% by weight of the milk-based beverage. In particular embodiments, the milk fat may be present in an amount between about 0.2% by weight of the milk-based beverage to about 35% by weight of the milk-based beverage. In particular embodiments, the milk fat may be present in an amount between about 0.4% by weight of the milk-based beverage to about 3.5% by weight of the milk-based beverage.

Suitable catechin-containing components for use in embodiments of milk-based beverage include, but are not limited to, tea components. In some embodiments, the catechin-containing component may be a green tea component, white tea component, or a black tea component. For example, the catechin-containing component may be green tea extract, concentrated green tea extract, or combinations thereof. In particular embodiments, the catechin-containing component may be present in an amount between about 25 ppm of the milk-based beverage to about 3000 ppm of the milk-based beverage. In other particular embodiments, the catechin-containing component may be present in an amount between about 50 ppm of the milk-based beverage to about 1000 ppm of the milk-based beverage. In still other particular embodiments, the catechin-containing component may be present in an amount between about 50 ppm of the milk-based beverage to about 500 ppm of the milk-based beverage.

Some embodiments of the milk-based beverage, may further comprise ascorbic acid. In particular embodiments, the ascorbic acid may be present in an amount between about 10 ppm of the milk-based beverage to about 1000 ppm of the milk-based beverage. In other particular embodiments, the ascorbic acid may be present in an amount between about 30 ppm of the milk-based beverage to about 400 ppm of the milk-based beverage. In still other particular embodiments, the ascorbic acid may be present in an amount between about 50 ppm of the milk-based beverage to about 200 ppm of the milk-based beverage.

In other embodiments, the milk-based beverage may further comprise a secondary antioxidant selected from the group consisting of alpha-tocopherols, vitamin A, vitamin E, ubiquinone, mineral selenium, manganese, melatonin, α-carotene, β-carotene, lycopene, lutein, zeanthin, crypoxanthin, reservatol, eugenol, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, phytic acid, ascorbyl palmitate, propyl gallate, and combinations thereof.

In particular embodiments, the secondary antioxidant may be present in an amount between about 10 ppm of the milk-based beverage to about 2000 ppm of the milk-based beverage. In other particular embodiments, the secondary antioxidant may be present in an amount between about 30 ppm of the milk-based beverage to about 1000 ppm of the milk-based beverage. In still other particular embodiments, the secondary antioxidant may be present in an amount between about 30 ppm of the milk-based beverage to about 500 ppm of the milk-based beverage.

In some embodiments, the milk-based beverage may further comprise a juice. In some embodiments, a juice may be present in an amount between 1% by weight to about 80% by weight of the milk based beverage. In other embodiments, a juice may be present in an amount between 2% by weight to about 50% by weight of the milk based beverage. In still other embodiments, a juice may be present in an amount between 2% by weight to about 25% by weight of the milk based beverage. Suitable juices may include, but are not limited to, orange juice, lemon juice, lime juice, grapefruit juice, apple juice, blueberry juice, raspberry juice, pomegranate juice, grape juice, and the like or combinations thereof.

In other embodiments, the milk-based beverage may further comprise elemental calcium or a calcium compound such as a calcium salt, a calcium complex, or a metastable calcium compound. For example, elemental calcium may be present in an amount between 0.005% by weight to about 1% by weight of the milk based beverage. In another instance, a calcium compound may be present in an amount between 0.05% by weight to about 10% by weight of the milk based beverage. Suitable calcium compounds may include, but are not limited to, calcium citrate, calcium lactate, calcium malate, calcium lactate citrate, calcium citrate malate, monocalcium phosphate, tricalcium phosphate, calcium gluconate, or the like, or combinations thereof.

In some embodiments, the milk-based beverage may include additional components such as, but not limited to, sweeteners, flavorings, colorings, carbonation, or the like, or combinations thereof.

Embodiments of the milk-based beverage may be acidified. For example, some embodiments of the milk-based beverage may have a pH between about 2.5 to about 7.5. In other embodiments, the milk-based beverage may have a pH between about 3.0 to about 6.5. In still other embodiments, milk-based beverage may have a pH between about 3.4 to about 4.6.

Without being bound by theory, it is believed that the addition of the catechin-containing component to the milk-based beverage prevents photo-oxidation of the milk fat. Thus, the catechin-containing component may also prevent any odor or taste of rancid milk fat (i.e., rancidity) from being perceived by a consumer. Addition of ascorbic acid and/or a secondary antioxidant may further prevents photo-oxidation of the milk fat. In some embodiments, catechin-containing component, the ascorbic acid, and/or the secondary antioxidant may further prevent milk protein photo-oxidation and thus, prevent any odor or taste of oxidized milk protein from being perceived by a consumer.

Thus, some embodiments of the milk-based beverage may be shelf stable. For instance, in some embodiments of the milk based beverage, rancidity of fat flavors is prevented in the milk-based beverage for at least 5 days at a light exposure up to about 2000 Langleys (i.e., calorie per square centimeter). Thus, some embodiments of the milk-based beverage may be shelf stable. For instance, in some embodiments of the milk based beverage, rancidity of fat flavors is prevented in the milk-based beverage for at least 7 days at a sunlight exposure up to about 3000 Langleys.

In other embodiments of the milk based beverage, rancidity of fat flavors is prevented in the milk-based beverage for at least 6 months at a temperature between about 30° F. and about 120° F. and at a light exposure up to about 3000 Langleys.

The present disclosure also provides a method for preventing off-flavors in a milk-based beverage comprising a milk component including milk fat. The method comprises adding a catechin-containing component to the milk-based beverage. Embodiments of the milk-based beverage may be the same as embodiments of the milk-based beverage described herein above. Embodiments of the catechin-containing component may be the same as embodiments of the catechin-containing component described herein above.

Embodiments of the method may further comprise adding ascorbic acid to the milk-based beverage. In particular embodiments, the ascorbic acid may be added in an amount between about 10 ppm of the milk-based beverage to about 1000 ppm of the milk-based beverage. In other particular embodiments, the ascorbic acid may be present in an amount between about 30 ppm of the milk-based beverage to about 400 ppm of the milk-based beverage. In still other particular embodiments, the ascorbic acid may be present in an amount between about 50 ppm of the milk-based beverage to about 200 ppm of the milk-based beverage.

In addition, embodiments of the method may further comprising adding a secondary antioxidant to the milk-based beverage, wherein the secondary antioxidant is selected from the group consisting of alpha-tocopherols, vitamin A, vitamin E, ubiquinone, mineral selenium, manganese, melatonin, α-carotene, β-carotene, lycopene, lutein, zeanthin, crypoxanthin, reservatol, eugenol, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, phytic acid, ascorbyl palmitate, propyl gallate, and combinations thereof.

In particular embodiments, the secondary antioxidant may be added in an amount between about 10 ppm of the milk-based beverage to about 2000 ppm of the milk-based beverage. In other particular embodiments, the secondary antioxidant may be present in an amount between about 30 ppm of the milk-based beverage to about 1000 ppm of the milk-based beverage. In still other particular embodiments, the secondary antioxidant may be present in an amount between about 30 ppm of the milk-based beverage to about 500 ppm of the milk-based beverage.

In addition, embodiments of the method may further comprising adding a juice to the milk-based beverage, wherein the juice may be, but is not limited to, orange juice, lemon juice, lime juice, grapefruit juice, apple juice, blueberry juice, raspberry juice, pomegranate juice, grape juice, and the like or combinations thereof. In some embodiments, a juice may be present in an amount between 1% by weight to about 80% by weight of the milk based beverage. In other embodiments, a juice may be present in an amount between 2% by weight to about 50% by weight of the milk based beverage. In still other embodiments, a juice may be present in an amount between 2% by weight to about 25% by weight of the milk based beverage.

In addition, embodiments of the method may further comprising adding a elemental calcium or a calcium compound such as a calcium salt, a calcium complex, or a metastable calcium compound. For example, elemental calcium may be present in an amount between 0.005% by weight to about 1% by weight of the milk based beverage. In another instance, a calcium compound may be present in an amount between 0.05% by weight to about 10% by weight of the milk based beverage. Suitable calcium compounds may include, but are not limited to, calcium citrate, calcium lactate, calcium malate, calcium lactate citrate, calcium citrate malate, monocalcium phosphate, tricalcium phosphate, calcium gluconate, or the like, or combinations thereof.

Another embodiment is further illustrated below in the example which is not to be construed in any way as imposing limitations upon the scope of this disclosure. On the contrary, it is to be clearly understood that resort may be had to various other embodiments, modifications, and equivalents thereof which, after reading the description therein, may suggest themselves to those skilled in the art without departing from the scope of this disclosure and the appended claims.

### EXAMPLE 1

A Sample A and an embodiment of a milk-based beverage (Sample B) was made according to the formulations provided in Table 1.

TABLE 1

| | Sample A | | Sample B | |
|---|---|---|---|---|
| Water | 802.5 | (grams) | 802.09 | (grams) |
| Monocalcium Phosphate | 2 | | 2 | |
| Calcium Lactate Citrate | 2.2 | | 2.2 | |
| (Purac America Inc.) | | | | |
| Sugar | 80 | | 80 | |
| Cream Base 2238 | 113 | | 113 | |
| (Galloway Company) | | | | |
| Green Tea Extract | 0 | | 0.24 | |
| (Sunphenone 70H from | | | | |
| Taiyo International) | | | | |
| Ascorbic Acid | 0 | | 0.17 | |
| Lactic Acid | 0.3 | | 0.3 | |
| Flavors | As required | | As required | |
| Total | 1000 | grams | 1000 | grams |

All the components were added to water while mixing. The beverages were packaged into clear glass bottles and pasteurized at 70° C. for 20 minutes. Some Sample A and Sample B bottles were put into a Ci5000 Weather-Ometer to attain the exposure equivalent to 3000 Langley. Additional Sample A bottles were not exposed to the light. These additional Sample A bottles were used as control samples. The exposed samples and control samples were evaluated by a taste panel of eight individuals. The Sample A exposed to the light was rejected unanimously by the panel as rancid, cardboard and sun-struck. Sample B was described as comparable to the control and still retaining original dairy notes without any off-notes caused by oxidation.

### EXAMPLE 2

A Sample A and an embodiment of a milk-based beverage (Sample B) was made according to the formulations provided in Table 2.

TABLE 2

| | Sample A | | Sample B | |
|---|---|---|---|---|
| Water | 802.5 | (grams) | 802.35 | (grams) |
| Monocalcium Phosphate | 2 | | 2 | |
| Calcium Lactate Citrate | 2.2 | | 2.2 | |
| (Purac America Inc.) | | | | |
| Sugar | 80 | | 80 | |
| Cream Base 2238 | 113 | | 113 | |
| (Galloway Company) | | | | |
| Green Tea Extract | 0 | | 0.15 | |
| (Sunphenone 70H from | | | | |
| Taiyo International) | | | | |
| Lactic Acid | 0.300 | | 0.3 | |
| Flavors | As required | | As required | |
| Total | 1000 | grams | 1000 | grams |

All the components were added to water while mixing. The beverages were carbonated with 1.8 to 2.4 volumes of CO₂ and packaged into clear glass bottles and pasteurized at 70° C. for 20 minutes. Some Sample A and Sample B bottles were put into a Ci5000 Weather-Ometer to attain the exposure equivalent to 3000 Langley. Additional Sample A bottles were not exposed to the light. These additional Sample A bottles were used as control samples. The exposed samples and control samples were evaluated by a taste panel of eight individuals. The Sample A exposed to the light was rejected unanimously by the panel as rancid, cardboard and sun-struck. Sample B was described as comparable to the control and still retaining original dairy notes without any off-notes caused by oxidation.

It should be understood that the foregoing relates to particular embodiments and that numerous changes may be made therein without departing from the scope of this disclosure as defined from the following claims.

We claim:

1. A milk-based beverage comprising:
a milk component including milk fat, wherein the milk fat is present in an amount of at least about 0.2% by weight of the milk-based beverage; and
a catechin-containing component, wherein the catechin-containing component prevents off-flavors in the milk-based beverage.

2. The milk-based beverage of claim 1, wherein the milk fat is present in an amount between about 0.2% by weight of the milk-based beverage to about 35% by weight of the milk-based beverage.

3. The milk-based beverage of claim 1, wherein the milk component comprises cream, whole fat milk, 2% milk fat milk, semi-skimmed milk, 1% milk fat milk, powdered whole fat milk, powdered semi-skimmed milk, or combinations thereof.

4. The milk-based beverage of claim 1, wherein the milk component is present in an amount of 1% by weight of the milk-based beverage to about 100% by weight of the milk-based beverage.

5. The milk-based beverage of claim 1, wherein the catechin-containing component is present in an amount between about 25 ppm of the milk-based beverage to about 3000 ppm of the milk-based beverage.

6. The milk-based beverage of claim 1, wherein the catechin-containing component comprises a tea component.

7. The milk-based beverage of claim 6, wherein the catechin-containing component is a green tea component selected from the group of green tea extract, concentrated green tea extract, or combinations thereof.

8. The milk-based beverage of claim 1, further comprising ascorbic acid.

9. The milk-based beverage of claim 8, wherein the ascorbic acid is present in an amount between about 10 ppm of the milk-based beverage to about 1000 ppm of the milk-based beverage.

10. The milk-based beverage of claim 1, further comprising secondary antioxidants selected from the group consisting of alpha-tocopherols, vitamin A, vitamin E, ubiquinone, mineral selenium, manganese, melatonin, α-carotene, β-carotene, lycopene, lutein, zeanthin, crypoxanthin, reservatol, eugenol, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, phytic acid, ascorbyl palmitate, propyl gallate, and combinations thereof.

11. The milk-based beverage of claim 1, wherein the pH of the milk-based beverage is between about 2.5 to about 7.5.

12. The milk-based beverage of claim 1, wherein the catechin-containing component prevents photo-oxidation of the milk fat.

13. The milk-based beverage of claim 1, wherein the milk-based beverage is shelf stable.

14. The milk-based beverage of claim 1, wherein rancidity of fat flavors is prevented in the milk-based beverage for at least 5 days at a light exposure up to about 2000 Langleys.

15. The milk-based beverage of claim 1, wherein rancidity of fat flavors is prevented in the milk-based beverage for at least 6 months at a temperature between 30° F. and about 120° F. and at a light exposure up to about 3000 Langleys.

16. A method for preventing off-flavors in a milk-based beverage comprising a milk component including milk fat, wherein the milk fat is present in an amount of at least about 0.2% by weight of the milk-based beverage, the method comprising adding a catechin-containing component to the milk-based beverage.

17. The method of claim 16, wherein the milk fat is present in an amount between about 0.2% by weight of the milk-based beverage to about 35% by weight of the milk-based beverage.

18. The method of claim 16, wherein the catechin-containing component is present in an amount between about 25 ppm of the milk-based beverage to about 3000 ppm of the milk-based beverage.

19. The method of claim 16, wherein the catechin-containing component comprises a tea component.

20. The method of claim 19, wherein the catechin-containing component is a green tea component selected from the group of green tea extract, concentrated green tea extract, or combinations thereof.

21. The method of claim 16, further comprising adding ascorbic acid to the milk-based beverage.

22. The method of claim 16, further comprising adding a secondary antioxidant to the milk-based beverage, wherein the secondary antioxidant is selected from the group consisting of alpha-tocopherols, vitamin A, vitamin E, ubiquinone, mineral selenium, manganese, melatonin, α-carotene, β-carotene, lycopene, lutein, zeanthin, crypoxanthin, reservatol, eugenol, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, phytic acid, ascorbyl palmitate, propyl gallate, and combinations thereof.

23. The method of claim 16, wherein the pH of the milk-based beverage is between about 2.5 to about 7.5.

24. The method of claim 16, wherein the catechin-containing component prevents photo-oxidation of the milk fat.

25. The method of claim 16, wherein the milk-based beverage is shelf stable.
